(19) United States
(12) Patent Application Publication
(10) Pub. No.: US 2011/0313833 A1
(43) Pub. Date: Dec. 22, 2011

(54) RECONSTRUCTING THE ONLINE FLOW OF RECOMMENDATIONS

(75) Inventors: Thore Graepel, Cambridge (GB); Ralf Herbrich, Cambridge (GB)

(73) Assignee: Microsoft Corporation, Redmond, WA (US)

(21) Appl. No.: 12/818,170

(22) Filed: Jun. 18, 2010

(51) Int. Cl. G06Q 30/00

(52) U.S. Cl. 705/14.16

(57) ABSTRACT

Online recommendations are tracked through a forwarding service. For example, a user may send an email to a friend recommending a product specified at a web site identified by a URI embedded in the email. Before sending the email, the user submits the URI to a forwarding service, which returns a new URI mapped to the original URI and to the recommending user. The recommending user can then recommend the web site by forwarding the new URI to the friend. If the friend selects the recommended URI to review the web site, the forwarding service records the decision to review the web site and directs the friend to the recommended web site. The forwarding service maintains a database of recommendations made by the recommending user, recommendation consumed by the friend, etc. Incentives can be provided to the recommending user and the friend to encourage recommendations.

### CROSS-REFERENCE TO RELATED APPLICATIONS

The present application is related to U.S. patent application Ser. No. ______ [MS329603.01], entitled “Pricing in Social Advertising” and filed on ______, specifically incorporated by reference herein for all that it discloses or teaches.

### BACKGROUND

Personal recommendations and word-of-mouth advertising can greatly influence an individual's purchase decision. Generally, a consumer is more likely to purchase a product or service based on referral from someone they know and/or trust than based on an independent advertisement. With the arrival of online communication services, such as email, blogs, microblogging services, social networking services, and electronic commerce sites, personal recommendations and word-of-mouth advertising proliferate in an online fashion. However, such proliferation is not generally trackable by the vendors most interested in understanding and promoting such effective marketing activities.

### SUMMARY

Implementations described and claimed herein address the foregoing problems by tracking recommendations through a forwarding service. In one example, a user may send an email to a friend recommending a product specified at a particular web site (e.g., identified by a Uniform Resource Identifier (URI) embedded in the email). Before sending the email containing the URI, the user submits the URI to a forwarding service, which associates the recommended URI with an identifier of the recommending user and returns a new URI that is mapped to the original URI and to the recommending user. The recommending user can then recommend the web site by forwarding the new URI to the friend. If the friend selects the new URI to review the web site, the forwarding service records the friend's decision to review the web site and directs the friend to the recommended web site. The forwarding service maintains a database of recommendations made by the recommending user, recommendation consumed (e.g., acted on) by the friend, whether the friend visited the recommended web site, etc. In this manner, the forwarding service can provide such statistics to an ad service, which can provide incentives to the recommending user and the friend and gain improved understanding of the marketplace. Example incentives may include an accumulation of points by the recommending user, a discount to the friend if a purchase is made in response to the recommendation, etc.

Other implementations are also described and recited herein.

### BRIEF DESCRIPTIONS OF THE DRAWINGS

FIG. 1 illustrates an example recommendation flow employing a forwarding service for recommendations.

FIG. 2 illustrates an example forwarding service managing a recommendation.

FIG. 3 illustrates an example forwarding service managing multiple recommendations in a recommendation flow.

FIG. 4 illustrates example operations for a recommending phase of tracking online recommendations.

FIG. 5 illustrates example operations for a consuming phase of tracking online recommendations.

FIG. 6 illustrates an example system that may be useful in implementing the described technology.

### DETAILED DESCRIPTIONS

As an initial matter, a URI is an example of a resource identifier and represents a string of characters used to identify a resource on a network. A universal resource locator (URL) is an example type of URI that identifies both a network resource and a means of accessing the network resource. For example, the best-known example of a URL is the “address” of a web page on the World Wide Web, such as “http://www.microsoft.com”, wherein the URI scheme “http” implies that a representation of the identified network resource may be obtained via HTTP from a network host named “www.microsoft.com”. A universal resource name (URN) is another example type of URI.

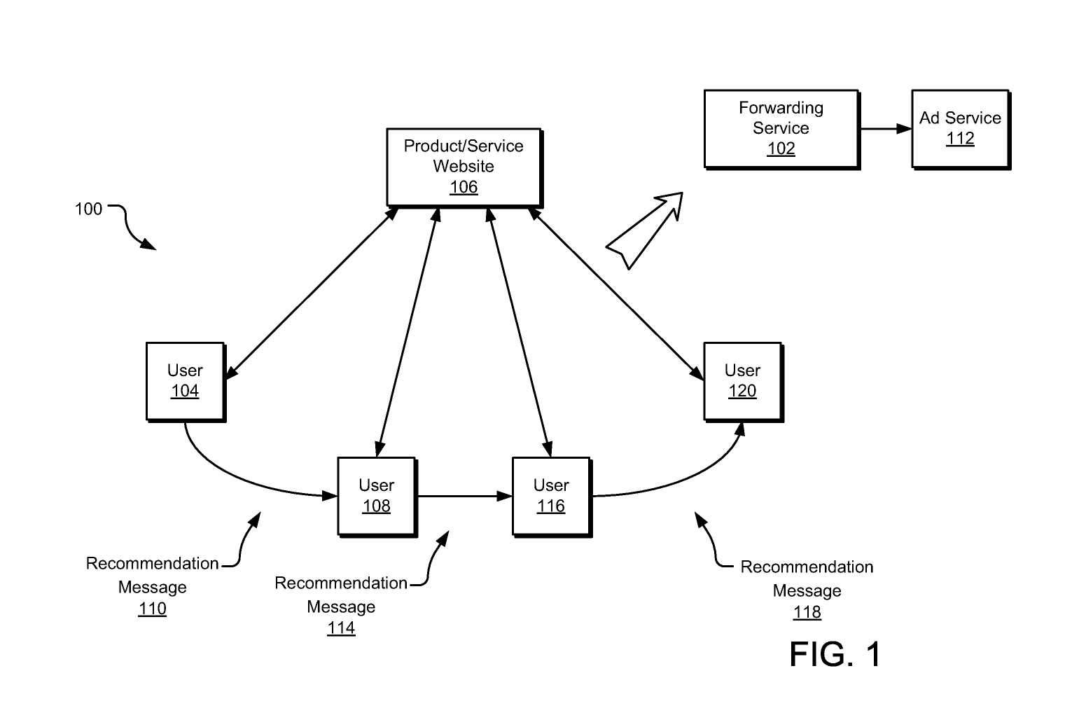

FIG. 1 illustrates an example recommendation flow 100 employing a forwarding service 102 for recommendations. In the illustrated example, a user 104 visits a network resource (such as a product/service website 106, a web service, a file transfer protocol (FTP) resource, a data storage system, etc.) and wishes to recommend it to a friend (e.g., a user 108). The recommending user 104, therefore, transfers the URI of the network resource into a recommendation message 110 to send it to the consuming user 108. Note: Users are designated in the figures by labeled blocks and are intended to represent the individual users and/or their computing systems.

Prior to triggering the transmission of the recommendation message 110 to the user 108, the user 104 submits the URI to the forwarding service 102, in a manner similar to using a URL shortening service. On the basis of this submission, the forwarding service 102 also receives a user identifier (UserID) of the user 104. Given the UserID and the URI, the forwarding service 102 generates a trackable recommendation identifier (e.g., another URI), which it returns to the user 104. The forwarding service 102 maintains a mapping between the originally received URI and the trackable recommendation identifier and another mapping between the UserID and the trackable recommendation identifier. These mappings may be unidirectional (e.g., from trackable recommendation identifier to original URI and/or UserID) or bidirectional (e.g., between trackable recommendation identifier to original URI and between trackable recommendation identifiers to UserID. Thereafter, upon receipt of the trackable recommendation identifier, the user 104 can trigger transmission of the recommendation message 110 containing the trackable recommendation identifier to the user 108.

Upon receiving the recommendation message 110, the user 108 can trigger the trackable recommendation identifier from the recommendation message 110 (e.g., selecting it, selecting a submission item from a context sensitive menu, sending the trackable recommendation identifier to a submission service, etc.), thereby submitting it to the forwarding service 102 for consumption (e.g., translation back into the original URI to the recommended network resource). In one implementation, a UserID of the user 108 may also be submitted to the forwarding service 102, which can create a user mapping between the trackable recommendation identifier and the UserID of the user 108.

In one implementation, the forwarding service 102 refers to recorded mappings of trackable recommendation identifiers and determines the original URI associated with the received trackable recommendation identifier, returning the original URI back to the user 108. Upon receipt of the original URI, the user 108 can select the original URI to navigate to or otherwise access the network resource (e.g., the product/service website 106) identified by the original URI. In another implementation, the user 108 is redirected or given access directly to the network resource without returning the original URI to the user 108.

In one implementation, the submission of the original URI to the forwarding service 102 credits the user 104 with an attempted recommendation, which may be rewarded by some measure maintained by the forwarding service 102, an ad service 112, or some other means. The ad service 112 is a component of the overall recommendation system that can query the forwarding service 102 for recommendation data relating to a user or a URI and take appropriate action. For example, the ad service 112 (or the forwarding service 102) can analyze such recommendation data and credit the user 104 with points toward a product or service rewards program, with a monetary credit, or with some other incentive. The forwarding service 102 and the ad service 112 are shown as residing in the same server 124, but it should be understood that the forwarding service 102, the ad service 112, and/or their components may be distributed over multiple computing systems.

Additionally, or in an alternative implementation, the submission of the trackable recommendation identifier to the forwarding service by the user 108 may also result in the user 104 receiving credit for a consumed recommendation. For example, because the forwarding service 102 maintains a user mapping between the trackable recommendation identifier and the UserID of the user 104, when the forwarding service 102 receives the submission from the user 108, the forwarding service 102 can find this user mapping and credit the user 104 with some benefit (e.g., points, credit, etc.).

Additionally, or in an alternative implementation, the submission of the trackable recommendation identifier and the UserID of the user 108 to the forwarding service by the user 108 may result in the user 108 receiving some benefit. For example, because the forwarding service 102 can maintain a mapping between the trackable recommendation identifier and the UserID of the user 108, when the forwarding service 102 receives the submission from the user 108, it can find this mapping and credit the user 108 with some benefit (e.g., points, credits, discounts, etc.). The UserID of the user 108 may also be passed to the ad service 112.

Both submission of the original URI by the user 104 and submission of the trackable recommendation identifier by the user 108 can also be recorded and analyzed by the forwarding service 102, the ad service 112, or some other means. For example, the ad service 112 may use such events in a statistical fashion to identify product/service trends, programming demographics, etc. As a specific example, the user 104 may be associated with a large number of recommendations of a television program popular among females between ages 13 and 16 (e.g., the user 104 frequently sends URLs of YouTube videos about the television programs to others). As such, an increase in recommendations by the user 104 and other similarly situated recommenders about a new television program may indicate a popular trending for the new program in the same demographic group.

Further, the user 108 can submit the trackable recommendation identifier or the original URI to the forwarding service 102 to send a recommendation message 114 containing a trackable recommendation identifier to another user 116. If the user 108 submits the trackable recommendation URI to the forwarding service 102, then the trackable recommendation identifier can provide a single level of recommendation (e.g., identifying only the user 108) or a flow of recommendations (e.g., identifying both the user 104 and the user 108). The forwarding service 102 can track the submission of user 108 as well as selection of the resulting trackable recommendation identifier by the user 116. In yet another recommendation stage, the user 116 can forward a recommendation message 118 containing a trackable recommendation identifier to another user 120. Records of all such recommendations can be maintained and/or analyzed by the forwarding service 102, the ad service 112 or other means.

It should be understood that the forwarding service 102 and/or the ad service 112 maintain recommendation data that can be used to credit the recommending and consuming users with something of value. For example, the forwarding service 102 may maintain a count of the number of consumed recommendations a recommending user has made and credit the recommending user with points towards a discounted purchase. Recommendation data may also be classified in particular product/service categories, based on timestamps, based on geographical or demographical parameters, etc. to develop a model of the marketplace relating to the recommended resources. The ad service 112 may also or alternatively maintain the recommendation data or query the forwarding service for the recommendation data, from which it can make crediting and/or incentive decisions (e.g., crediting the consuming user with a discount versus points).

In another alternative implementation, the original URI returned to the consuming user from the forwarding service 102 may also be modified to include one or more parameters to cause the network resource (e.g., the recommended website) to treat the consuming user differently than the general population. For example, the company publishing the recommended website may pay the forwarding service company a fee to map a discount parameter to the original URI. In this manner, the returned URI can include this parameter, and the web server accessed through the returned URI can redirect the consuming user to a web page that offers a discount to recommended consumers.

FIG. 1 has been described as processing a URI through a client interface (similar to an interface used to short URLs). In an alternative implementation, the recommending user can simply route the recommendation message through a forwarding service that automatically personalizes all (or a specifically marked subset) of the URIs found within the recommendation message before forwarding it on to a consuming user identified by the recommending user. In this manner, the recommending user can integrate the steps used to provide a recommendation (e.g., personalizing the URI and sending the recommendation). Furthermore, the forwarding service can also be more integrated in the recommendation procedure (e.g., it can detect when a recommendation was actually sent to a user and which user received it). Other implementations may also be employed.

The forwarding service 102 and/or the ad service 112 may reside in the cloud or be executed from a server within a local area network. For example, a forwarding service may be implemented within an email or unified communications server of an enterprise. Alternatively, an Internet or Web-based service (similar to a URL shortening service) may implement the forwarding service and/or the ad service.

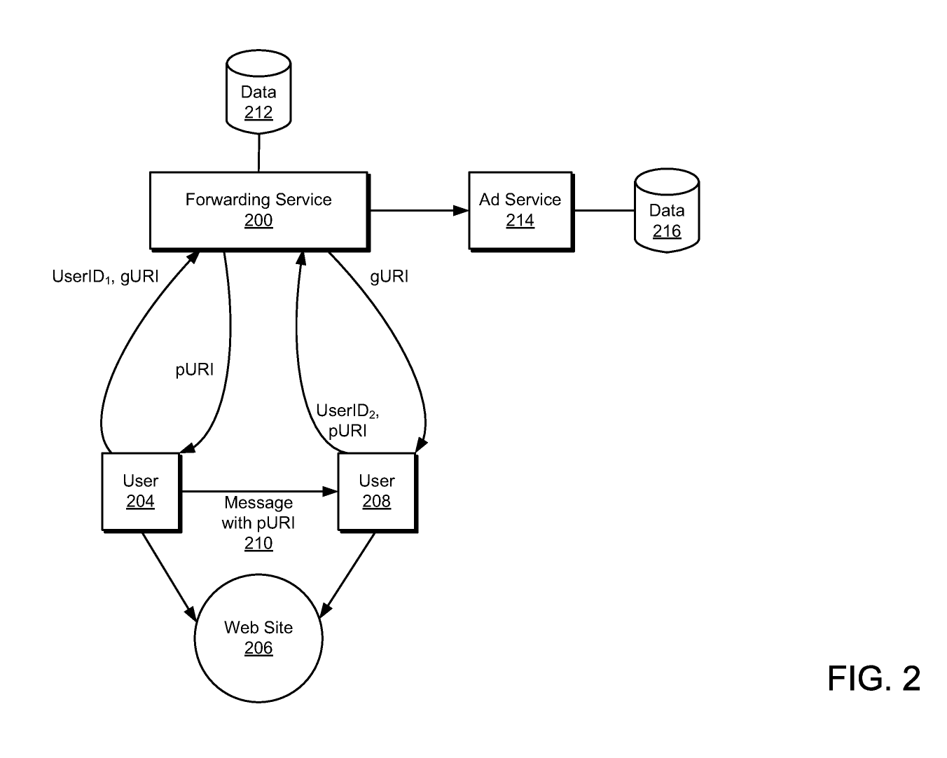

FIG. 2 illustrates an example forwarding service 200 managing a recommendation. A user 204 (e.g., a “recommending user”) may access a website 206 and decide to recommend it to another user 208 (e.g., a “consuming user”). In this context, the term “recommending user” identifies a user in a role of recommending a resource to another user, and the term “consuming user” identifies another user in a role of responding to a trackable recommendation by submitting a trackable recommendation identifier to the forwarding service 200. Note: The user 204 need not actually access the website 206 in order to obtain an accurate URI to the website 206, but accessing a website is a common method of obtaining an accurate URI (e.g., copying the URI from a web address field in a browser).

To recommend the website 206 to the user 208, the user 204 submits a user identifier (UserID₁) of the user 204 and the URI (gURI—generic URI) to the forwarding service 200. The gURI represents a recommended resource identifier. The forwarding service 200 creates a trackable recommendation identifier (pURI—personalized URI), a resource identifier mapping between the gURI and the pURI, and a user mapping between the UserID₁ and the pURI. The mappings are stored in a datastore 212 accessible by the forwarding service 212. The forwarding service 200 then sends the pURI back to the user 204, who sends a recommendation message 210 containing the pURI to the user 208.

Upon receipt of the recommendation message 210, the user 208 can “consume” the recommendation by triggering submission of the pURI in the recommendation message 210 (e.g., the pURI in the body of a recommendation email) and the user identifier (UserID₂) of the user 208 to the forwarding service 200. The forwarding service 200 records in the datastore 212 the consumption of the recommendation by the user 208 of the pURI, creates a mapping between the pURI and the UserID₂, finds the mapping associated with the pURI in the datastore 212, and returns the corresponding gURI to the user 208 (or redirects the user 208's browser to the resource identified by the gURI). In this manner, the user 208 can access the recommended web site 206.

By maintaining both the initial recommendation by the user 204 and the consumption of the recommendation by the user 208, the forwarding service 200, an ad service 214, or other means can track personal recommendations made online and their effectiveness. Furthermore, using the user mappings, consumed recommendations can be tracked back to the recommending user, who can be credited with a consumed recommendation and therefore rewarded with an incentive, award, or some other valuable benefit. For example, the recommending user associated with the pURI submitted by the consuming user may be awarded points that can be traded for other products or services. Records of such consumed recommendations can also be stored in and/or distributed to other datastores, such as datastore 216.

In an alternative implementation, the forwarding service 200 may also receive from the user 204 a recommendation qualifier, such as “like,” “dislike,” “refer,” etc. For example, if the user wishes to recommend that the friend 208 avoid buying a product reviewed at a particular URI, the user 204 can attribute a “dislike” recommendation qualifier to the submission of the UserID and gURI to the forwarding service 200. The user 204 may also annotate the returned pURI with text (“This product is AWFUL!”) in the recommendation message 210 before sending it to the user 208. Recommendation qualifiers may also be recorded by the forwarding service 200, stored in the datastore 212, and used by the forwarding service 200, the ad service 212, or other means to evaluate marketing trends, etc.

In yet another alternative implementation, the forwarding service 200 may also receive from the user 208 a consumption qualifier, such as “like,” “dislike,” “refer,” “ignore,” etc. For example, if the user 208 already knows about the recommended product or website or does not trust the recommendations of the user 204, the user 208 can attribute an “ignore” consumption qualifier to the submission of the UserID and pURI to the forwarding service 200. Consumption qualifiers may also be recorded by the forwarding service 200, stored in the datastore 212, and used by the forwarding service 200, the ad service 212, or other means to evaluate marketing trends, etc. Consumption qualifiers may also alter the way the forwarding service 200 responds to a consuming user's submission. For example, the forwarding service 200 may not return the gURI or redirect the user 208 to a recommended web site based on the receipt of an “ignore” consumption qualifier.

Other information may also be recorded by the forwarding service 200, including a recommending time stamp of the submission by the user 204, a consuming time stamp of the submission by the user 208, global positioning system (GPS) coordinates and other information, device type, whether the recommending user has actually purchased the recommended product/service, etc. For example, less credit may be attributed to a recommending user or a consuming user if a long period of time exists between a recommendation timestamp and a consuming timestamp. In another example, different levels of credit may be attributed to a recommending user or a consuming user depending on the geographic location of either user.

It should be understood that the trackable recommendation identifier may be sent to multiple recipients (e.g., via an email distribution list, a “tweet”, a blog posting, etc.). In this circumstance, the UserID of the recommending user is mapped to the trackable recommendation identifier so that the recommending user can receive credit from individual consumptions by any number of consuming users who trigger the trackable recommendation identifier. Moreover, although each consuming user triggered the same trackable recommendation identifier, unique mappings between the UserID of each consuming user and the trackable recommendation identifier may be recorded, so that each consuming user is credited with the consumed recommendation.

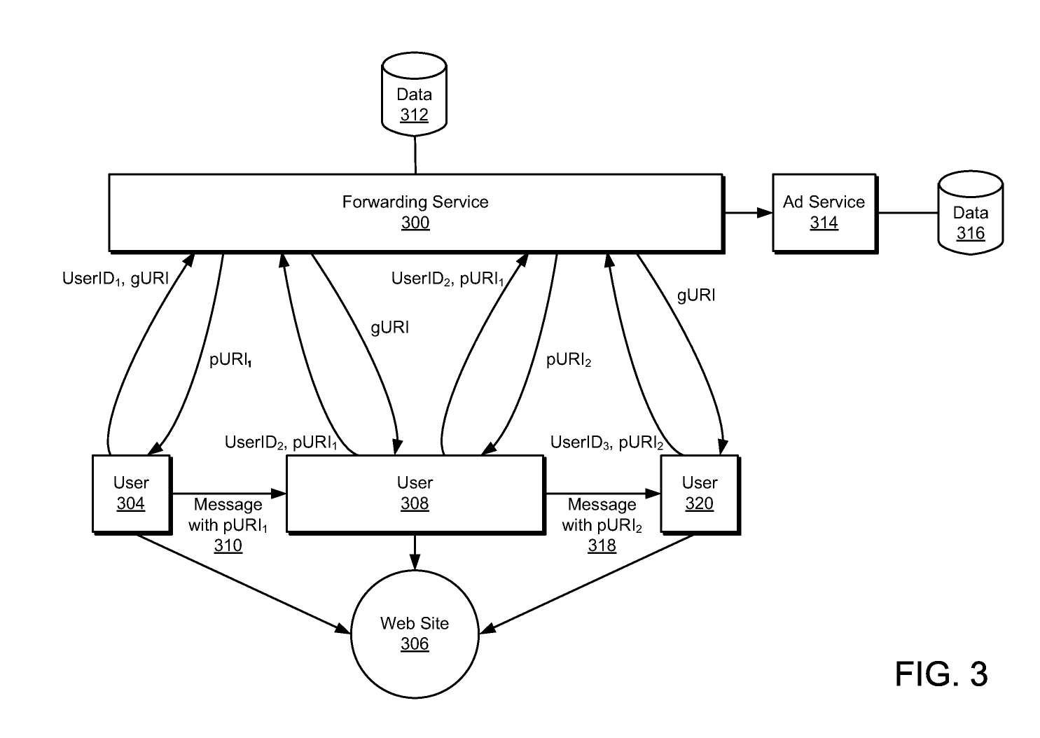

FIG. 3 illustrates an example forwarding service 300 managing multiple recommendations in a recommendation flow. A recommending user 304 may access a website 306 and decide to recommend it to a consuming user 308.

To recommend the website 306 to the user 308, the user 304 submits a user identifier (UserID₁) and the URI (gURI—generic URI) to the forwarding service 300. The forwarding service 300 creates a trackable recommendation identifier (pURI₁), a mapping between the gURI and the pURI₁, and a mapping between the UserID₁ and the pURI₁. The mappings are stored in a datastore 312 accessible by the forwarding service 312. The forwarding service 300 then sends the pURI₁ back to the user 304, who sends a recommendation message 310 containing the pURI₁ to the user 308.

Upon receipt of the recommendation message 310, the user 308 can trigger submission of the pURI in the recommendation message 310 (e.g., the pURI₁ in the body of a recommendation email) and the user identifier (UserID₂) of the user 308 to the forwarding service 300. The forwarding service 300 records in the datastore 312 the consumption of the recommendation by the user 308 of the pURI₁, creates a mapping between the pURI₁ and the UserID₂, finds the mapping associated with the pURI₁ in the datastore 312, and returns the corresponding gURI to the user 308 (or redirects the user 308's browser to the resource identified by the gURI). In this manner, the user 308 can access the web site 306. By maintaining both the initial recommendation by the user 304 and the consumption of the recommendation by the user 308, the forwarding service 300 can track personal recommendations made online and their effectiveness.

In the example of FIG. 3, the user 308 also decides to recommend the website 306 to another user 320. In this context, the user 308 now takes the role of a recommending user in relation to the user 320's role as a consuming user. In one implementation, not shown in FIG. 3, the user identifier of the user 320 (UserID₂) and the gURI of the website 306 are submitted to the forwarding service 300, which maps and records as described previously, and returns a new trackable recommendation identifier (pURI₂) to the user 308. The user 308 can then send a recommendation message 318 containing pURI₂ to the user 320. Upon receipt of the recommendation message 318, the user 320 can submit pURI₂ to the forwarding service 300. The forwarding service 300 records and maps as described previously, and returns the corresponding gURI to the user 320 (or redirects the user 320's browser to the resource identified by the gURI). In this manner, the user 320 can access the recommended web site 306. In this implementation, the forwarding service 300 maintains relevant recommendation information, but only one level of recommendation.

In an alternative implementation, as shown in FIG. 3, the user 308 can submit UserID₂ and pURI₁ to the forwarding service 300, which creates a new trackable recommendation identifier (pURI₂), a mapping between the gURI and the pURI₂, a mapping between the UserID and the pURI₂, and a new mapping showing the multiple levels of recommendation from user 304 to user 308 to user 320. In this manner, the forwarding service 300 can track propagation of recommendations through multiple users. The forwarding service 300 then sends the pURI₂ back to the user 308, who sends a recommendation message 318 containing the pURI₂ to the user 320. The number of recommendation levels maintained by the forwarding service 300 are unlimited by the described technology.

Upon receipt of the recommendation message 318, the user 320 can trigger submission of the pURI₂ in the recommendation message 318 and the user identifier (UserID₃) of the user 320 to the forwarding service 300. The forwarding service 300 records and maps as described previously, and returns the corresponding gURI to the user 320 (or redirects the user 320's browser to the resource identified by the gURI). In this manner, the user 320 can access the recommended web site 306.

Additional information may also be received by the forwarding service 300, including timestamps, GPS coordinates and other information, recommendation qualifiers, consumption qualifiers, etc. By maintaining the recommendation by the users 304 and 308 and the consumptions by the users 308 and 320, the forwarding service 300, an ad service 314, or other means can track personal recommendations made online and their effectiveness. Records of such recommendations can also be stored in and/or distributed to other datastores, such as datastore 316.

Some benefits to the described technology include measuring the effectiveness of recommendations, determining who can influence the purchasing actions of whom, how strong is this influence, etc. Furthermore, political campaigns can use trackable online recommendations to analyze the impact of various news items, the popularity of candidates and issues, etc.

By reconstructing the flow of recommendations, a forwarding service and/or ad service can reward individuals based on the actual causal influence associated with their online recommendations. A recommending user and/or a consuming user may be credited with any valuable reward, including mere recognition, tradable/marketable points, free or reduced priced goods/services, etc.

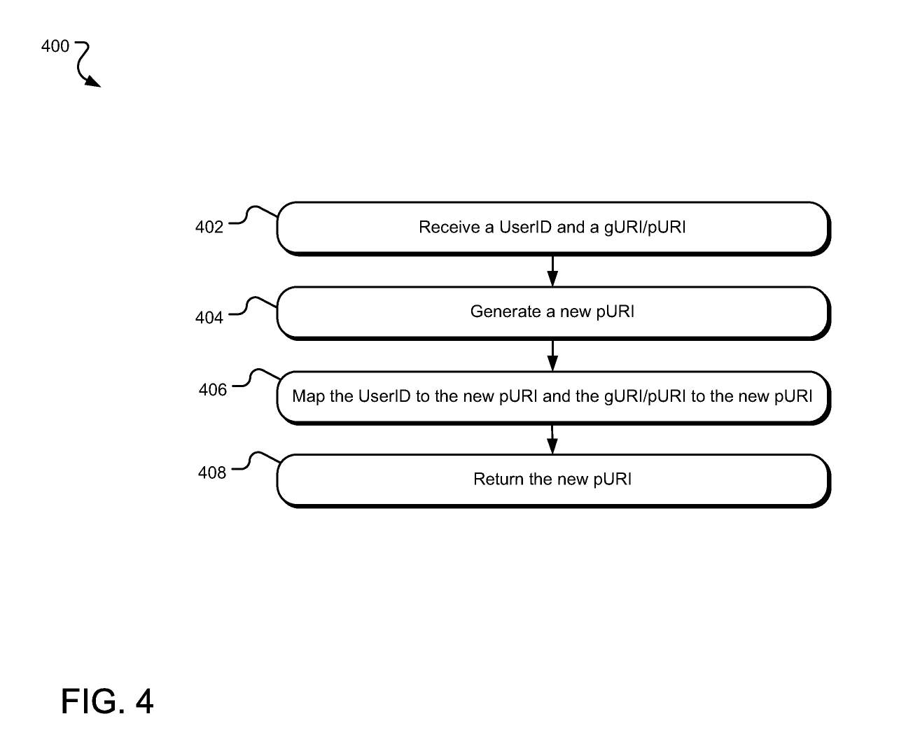

FIG. 4 illustrates example operations 400 for a recommending phase of tracking online recommendations. A receiving operation 402 receives a UserID and a gURI or pURI from a recommending user. For example, if the recommending user is recommending a previously untracked resource identifier, then the associated gURI is received via the receiving operation 402 to record the recommendation and generate a new trackable recommendation identifier (e.g., a new pURI) in a generating operation 404. In contrast, if the recommending user is recommending a previously generated trackable recommendation identifier, then the associated pURI is received via the receiving operation 402 to record the new recommendation and to generate a new trackable recommendation identifier (e.g., a new pURI) in the generating operation 404.

A mapping operation 406 maps the UserID to the new pURI and maps the received gURI or pURI to the new pURI. In this manner, the mapping allows the recommending user to be identified using the new pURI and allows the new pURI to be translated back into the gURI when the new pURI is submitted by a consuming user (i.e., the user that receives and acts on the recommendation). A sending operation 408 returns the new pURI to the recommending user.

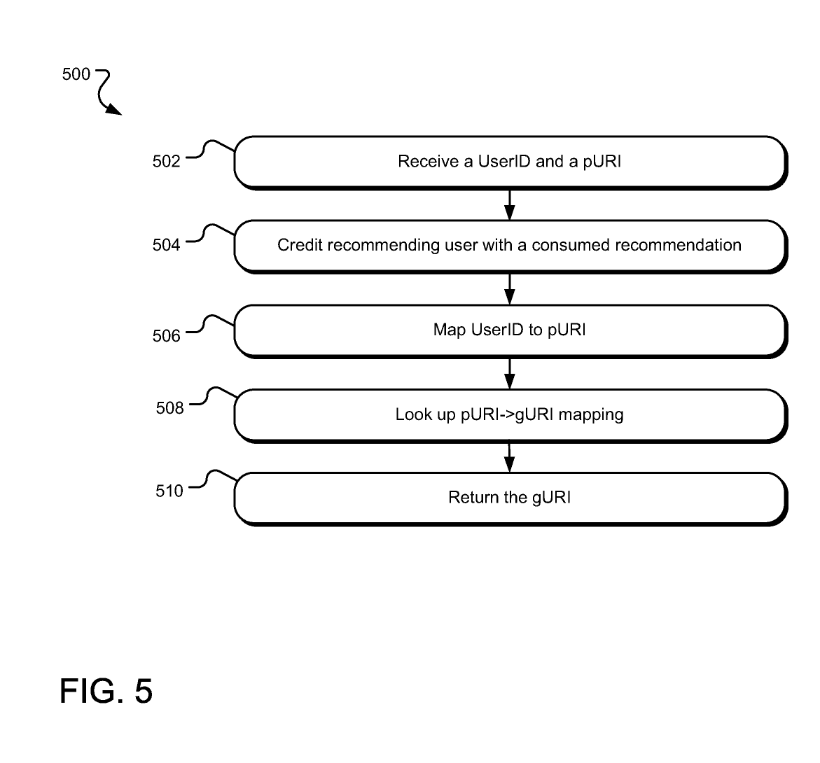

FIG. 5 illustrates example operations 500 for a consuming phase of tracking online recommendations. A receiving operation 502 receives a UserID and pURI from a consuming user. A credit operation 504 maps the received pURI to one or more recommending users based on one or more user mappings and credits such recommending users with a consumed recommendation. A mapping operation 506 maps the UserID of the consuming user to the pURI. In this manner, the mapping allows the consuming user to be identified using the pURI. In an alternative implementation, receipt and mapping of the consuming user's user identifier may be omitted.

A translation operation 508 looks up a gURI based on the pURI. In some circumstances, the translation operation 508 requires only one lookup stage (e.g., if the pURI is associated with a single level recommendation). In other circumstances, the translation operation 508 may required multiple lookup stages (e.g., if the pURI is associated with a single level recommendation). The translation operation 508 yields a gURI associated with the original recommendation, and a returning operation 510 returns the gURI to the consuming user (or redirects the consuming user's browser to the network resource identified by the gURI).

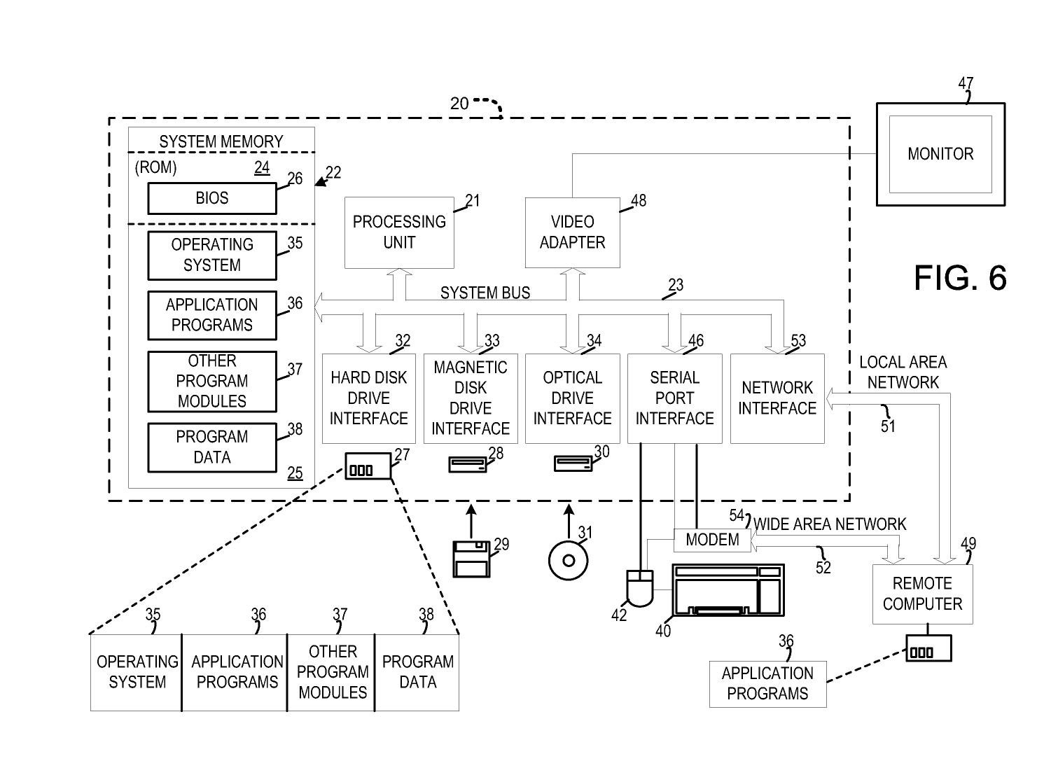

FIG. 6 illustrates an example system that may be useful in implementing the described technology. The example hardware and operating environment of FIG. 6 for implementing the described technology includes a computing device, such as general purpose computing device in the form of a gaming console or computer 20, a mobile telephone, a personal data assistant (PDA), a set top box, or other type of computing device. In the implementation of FIG. 6, for example, the computer 20 includes a processing unit 21, a system memory 22, and a system bus 23 that operatively couples various system components including the system memory to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer; the invention is not so limited.

The system bus 23 may be any of several types of bus structures including a memory bus or memory controller, a peripheral bus, a switched fabric, point-to-point connections, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, random access memories (RAMs), read only memories (ROMs), and the like, may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the invention is not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 6. The logical connections depicted in FIG. 6 include a local-area network (LAN) 51 and a wide-area network (WAN) 52. Such networking environments are commonplace in office networks, enterprise-wide computer networks, intranets and the Internet, which are all types of networks.

When used in a LAN-networking environment, the computer 20 is connected to the local network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are example and other means of and communications devices for establishing a communications link between the computers may be used.

In an example implementation, a forwarding service, an ad service, and other modules and services may be embodied by instructions stored in memory 22 and/or storage devices 29 or 31 and processed by the processing unit 21. A UserIDs, mappings, recommendation qualifiers, timestamps, and other data may be stored in memory 22 and/or storage devices 29 or 31 as persistent datastores. Further, a forwarding service and an ad service represent hardware and/or software configured to provide service functionality for network-connected systems. Such services may be implemented using a general purpose computer and specialized software (such as a server executing service software), a special purpose computing system and specialized software (such as a mobile device or network appliance executing service software), or other computing configurations.

The embodiments of the invention described herein are implemented as logical steps in one or more computer systems. The logical operations of the present invention are implemented (1) as a sequence of processor-implemented steps executing in one or more computer systems and (2) as interconnected machine or circuit modules within one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The above specification, examples, and data provide a complete description of the structure and use of exemplary embodiments of the invention. Since many embodiments of the invention can be made without departing from the spirit and scope of the invention, the invention resides in the claims hereinafter appended. Furthermore, structural features of the different embodiments may be combined in yet another embodiment without departing from the recited claims.

What is claimed is:

1. One or more computer-readable storage media encoding computer-executable instructions for executing a computing process on a computer system, the computing process comprising:
generating a trackable recommendation identifier based on a recommended resource identifier received from a recommending user; and
crediting the recommending user with a consumed recommendation based on the trackable recommendation identifier, responsive to receipt of the trackable recommendation identifier from a consuming user.

2. The one or more computer-readable storage media of claim 1 wherein the generating operation comprises:
storing a resource identifier mapping between the trackable recommendation identifier and the recommended resource identifier; and
returning the trackable recommendation identifier to the recommending user.

3. The one or more computer-readable storage media of claim 1 wherein the generating operation comprises storing a user mapping between the trackable recommendation identifier and a user identifier of the recommending user and the crediting operation identifies the recommending user to credit based on the user mapping.

4. The one or more computer-readable storage media of claim 1 wherein the computing process further comprises:
storing a user mapping between the trackable recommendation identifier and a user identifier of the recommending user;
identifying the recommending user based on the stored user mapping, responsive to receipt of the trackable recommendation identifier from the consuming user; and
forwarding the user identifier of the recommending user to an advertising service, responsive to identifying operation.

5. The one or more computer-readable storage media of claim 1 wherein the computing process comprises:
determining the recommended resource identifier based on the trackable recommendation identifier received from the consuming user, wherein the recommended resource identifier identifies a network resource recommended by the recommending user to the consuming user;
returning the recommended resource identifier to the consuming user, responsive to the determining operation.

6. The one or more computer-readable storage media of claim 1 wherein the computing process comprises:
determining the recommended resource identifier based on the trackable recommendation identifier received from the consuming user, wherein the recommended resource identifier identifies a network resource recommended by the recommending user to the consuming user;
redirecting the consuming user to the network resource identified by the recommended resource identifier, responsive to the determining operation.

7. The one or more computer-readable storage media of claim 1 wherein the computing process comprises:
recording a recommendation qualifier in association with the trackable recommendation identifier, responsive to receipt of the recommended resource identifier and the recommendation qualifier from the recommending user.

8. The one or more computer-readable storage media of claim 1 wherein the computing process comprises:
recording a consumption qualifier in association with the trackable recommendation identifier, responsive to receipt of the trackable recommendation identifier and the consumption qualifier from the consuming user.

9. The one or more computer-readable storage media of claim 1 wherein the computing process comprises:
recording a user identifier of the consuming user in association with the trackable recommendation identifier, responsive to receipt of the trackable recommendation identifier and the user identifier from the consuming user.

10. The one or more computer-readable storage media of claim 1 wherein a consumed recommendation represents submission of a trackable recommendation identifier by a consuming user, the trackable recommendation identifier being trackable to the recommending user based on a resource identifier mapping associated with a user identifier of the recommending user.

11. A forwarding service server configured to:
generate a trackable recommendation identifier based on a recommended resource identifier received from a recommending user; and
credit the recommending user with a consumed recommendation based on the trackable recommendation identifier, responsive to receipt of the trackable recommendation identifier from a consuming user.

12. A method comprising:
generating a trackable recommendation identifier based on a recommended resource identifier received from a recommending user; and
crediting the recommending user with creating a recommendation consumed by a consuming user based on receipt of the trackable recommendation identifier from the consuming user.

13. The method of claim 12 wherein the generating operation comprises:
storing a resource identifier mapping between the trackable recommendation identifier and the recommended resource identifier; and
returning the trackable recommendation identifier to the recommending user.

14. The method of claim 12 wherein the generating operation comprises storing a user mapping between the trackable recommendation identifier and a user identifier of the recommending user and the crediting operation identifies the recommending user to credit based on the user mapping.

15. The method of claim 12 further comprising:
storing a user mapping between the trackable recommendation identifier and a user identifier of the recommending user;
identifying the recommending user based on the stored user mapping, responsive to receipt of the trackable recommendation identifier from the consuming user; and
forwarding the user identifier of the recommending user to an advertising service, responsive to identifying operation.

16. The method of claim 12 further comprising:
determining the recommended resource identifier based on the trackable recommendation identifier received from the consuming user, wherein the recommended resource identifier identifies a network resource recommended by the recommending user to the consuming user;
returning the recommended resource identifier to the consuming user, responsive to the determining operation.

17. The method of claim 12 further comprising:
recording a recommendation qualifier in association with the trackable recommendation identifier, responsive to receipt of the recommended resource identifier and the recommendation qualifier from the recommending user.

18. The method of claim 12 further comprising:
recording a consumption qualifier in association with the trackable recommendation identifier, responsive to receipt of the trackable recommendation identifier and the consumption qualifier from the consuming user.

19. The method of claim 12 further comprising:
recording a user identifier of the consuming user in association with the trackable recommendation identifier, responsive to receipt of the trackable recommendation identifier and the user identifier from the consuming user.

20. The method of claim 12 wherein a consumed recommendation represents submission of a trackable recommendation identifier by a consuming user, the trackable recommendation identifier being trackable to the recommending user based on a resource identifier mapping associated with a user identifier of the recommending user.
